(19) United States
(12) Patent Application Publication
(10) Pub. No.: US 2026/0235412 A1
(43) Pub. Date: Aug. 13, 2026

(54) NAVIGATION MAP AND POINT OF INTEREST AWARENESS DISPLAY

(71) Applicant: Toyota Jidosha Kabushiki Kaisha, Toyota-shi Aichi-ken (JP)

(72) Inventors: Tyler La Monda, Fairfield, CA (US); Alexander Charles Granieri, Mountain View, CA (US)

(73) Assignee: Toyota Jidosha Kabushiki Kaisha, Toyota-shi Aichi-ken (JP)

(21) Appl. No.: 19/051,274

(22) Filed: Feb. 12, 2025

(51) Int. Cl. G01C 21/34; B60K 35/28; G01C 21/36

(52) U.S. Cl. CPC G01C 21/3476; B60K 35/28; G01C 21/3617; G01C 21/3638; G01C 21/367; G01C 21/3682; B60K 2360/166; B60K 2360/182; B60K 2360/1868; B60K 2360/191

(57) ABSTRACT

A navigation view can be presented on a first screen, and a point of interest (POI) view can be presented on a second screen. The POI view can be a broader view of a current region in which a vehicle is located. The POI view can include one or more objects without a real-world counterpart. A POI in the current region can be determined. A POI in the POI view can be caused to be highlighted as the vehicle approaches the POI.

### FIELD

The subject matter described herein relates in general to vehicle navigation maps and, more particularly, to user interaction with vehicle navigation maps.

### BACKGROUND

Many vehicles are equipped with a navigation system. A navigation system can aid in the navigating or routing of a vehicle from a starting point to a destination. A navigation map can be presented to a vehicle occupant.

### SUMMARY

In one respect, the present disclosure is directed to a method. The method can include presenting a navigation view on a first screen. The method can include presenting a point of interest (POI) view on a second screen. The POI view can be a broader view of a current region in which a vehicle is located. The POI view can include one or more objects without a real-world counterpart. The method can include determining a POI in the current region. The method can include causing a POI in the POI view to be highlighted as the vehicle approaches the POI.

In another respect, the present disclosure is directed to a system. The system can include a processor. The processor can be configured to present a navigation view on a first screen. The processor can be configured to present a point of interest (POI) view on a second screen. The POI view can be a broader view of a current region in which a vehicle is located. The POI view can include one or more objects without a real-world counterpart. The processor can be configured to determine a POI in the current region. The processor can be configured to cause a POI in the POI view to be highlighted as the vehicle approaches the POI.

### BRIEF DESCRIPTION OF THE DRAWINGS

FIG. 1 is an example of a vehicle.

FIG. 2 is an example of a system.

FIG. 3 is an example of a method.

FIG. 4 is an example of a split screen display.

FIGS. 5A-5C show an example of the split screen display over time, wherein a point of interest is highlighted by being rotated.

FIGS. 6A-6C show an example of the split screen display over time, wherein a point of interest is highlighted by a flyby.

FIG. 7 shows an example of a split screen display, wherein a point of interest is highlighted by a themed character.

FIG. 8 shows an example of a display, wherein points of interest are highlighted by themed characters.

### DETAILED DESCRIPTION

Navigation maps may provide passive information that must be manually highlighted by a vehicle occupant. Further, vehicle-navigation systems generally do not provide suggestions according to known preferences of occupants. As such, finding desired points of interest can be difficult for users.

According to arrangements described herein, a navigation view can be presented on a first screen, and a point of interest (POI) view can be presented on a second screen. The POI view can be a broader view of a current region in which a vehicle is located. The POI view can include one or more objects without a real-world counterpart. A POI in the current region can be determined. A POI in the POI view can be caused to be highlighted as the vehicle approaches the POI. Such arrangements can provide immersive map elements within a navigation map of a vehicle using passenger and/or route information to improve or enhance passenger awareness of POIs

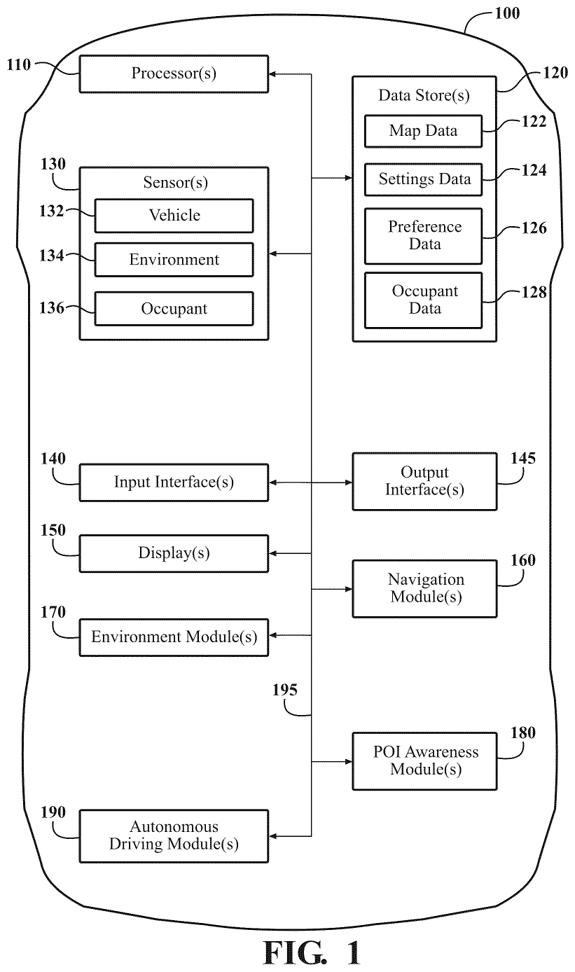

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIG. 1 is an example of a vehicle 100. As used herein, “vehicle” means any form of motorized or powered transport. In one or more implementations, the vehicle 100 can be an automobile, a land-based craft, a watercraft, an aircraft, or any other form of motorized or powered transport. The vehicle 100 may be operated manually by a human driver, semi-autonomously by a mix of manual inputs from a human driver and autonomous inputs by one or more vehicle computers, fully autonomously by one or more vehicle computers, or any combination thereof. The vehicle 100 can be configured to switch between these different operational modes.

The vehicle 100 can include various elements. Some of the possible elements of the vehicle 100 are shown in FIG. 1 and will now be described. It will be understood that it is not necessary for the vehicle 100 to have all of the elements shown in FIG. 1 or described herein. The vehicle 100 can have any combination of the various elements shown in FIG. 1. Further, the vehicle 100 can have additional elements to those shown in FIG. 1. In some arrangements, the vehicle 100 may not include one or more of the elements shown in FIG. 1. Further, while the various elements may be located on, onboard, or within a vehicle, it will be understood that one or more of these elements can be located external to the vehicle. Thus, such elements are not located on, onboard, within, or otherwise carried by the vehicle. Further, the elements shown may be physically separated by large distances. Indeed, one or more of the elements can be located remote from the vehicle 100. Some of the elements can be components of the vehicle 100 while some of the elements may not be components of the vehicle 100.

The vehicle 100 can include one or more processors 110, one or more data stores 120, one or more sensors 130, one or more input interfaces 140, one or more output interfaces 145, one or more displays 150, one or more navigation modules 160, one or more environment modules 170, one or more point of interest (POI) awareness modules 180, and/or one or more autonomous driving modules 190. Each of these elements will be described in turn below.

As noted above, the vehicle 100 can include one or more processors 110. “Processor” means any component or group of components that are configured to execute any of the processes described herein or any form of instructions to carry out such processes or cause such processes to be performed. The processor(s) 110 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 110 can include at least one hardware circuit (e.g., an integrated circuit) configured to carry out instructions contained in program code. In arrangements in which there is a plurality of processors 110, such processors can work independently from each other or one or more processors can work in combination with each other.

The vehicle 100 can include one or more data stores 120 for storing one or more types of data. The data store(s) 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 120 can be a component of the processor(s) 110, or the data store(s) 120 can be operatively connected to the processor(s) 110 for use thereby. The term “operatively connected,” as used throughout this description, can include direct or indirect connections, including connections without direct physical contact.

In one or more arrangements, the data store(s) 120 can include map data 122. The map data 122 can include maps of one or more geographic areas. In some instances, the map data 122 can include information or data on roads, traffic control devices, road markings, streetlights, structures, features, buildings, and/or landmarks in the one or more geographic areas. The map data 122 can be in any suitable form. In some instances, the map data 122 can include aerial views of an area. In some instances, the map data 122 can include ground views of an area, including 360-degree ground views. The map data 122 can include measurements, dimensions, distances, positions, coordinates, and/or information for one or more items included in the map data 122 and/or relative to other items included in the map data 122. The map data 122 can include a digital map with information about road geometry. In one or more arrangement, the map data 122 can include information about the ground, terrain, roads, surfaces, and/or other features of one or more geographic areas. The map data 122 can include elevation data in the one or more geographic areas. The map data 122 can define one or more ground surfaces, which can include paved roads, unpaved roads, land, and other things that define a ground surface. The map data 122 can be high quality and/or highly detailed.

In one or more arrangements, the data store(s) 120 can include settings data 124. The settings data 124 can include any data or information useful for generating an extended reality view of the external environment of the vehicle. The settings data 124 can be set by a vehicle occupant, vehicle manufacturer, or some other entity.

In some arrangements, the setting data 124 can include one or more pre-defined template structures. The template structures can include one or more themes, motifs, or styles that can be used to alter the presentation of the external driving environment to a vehicle occupant. For instance, the template structures can be of a particular artist or art movement (e.g., a Pablo Picasso style or an impressionist style), particular movie or television program (e.g., a Star Wars style or a sci-fi style), a particular book or book series, particular time period or event in history (e.g., the 1930s, the 1980s, 19^{th} century, the future, period costume, vintage car, etc.), a particular location or setting (e.g., tropical island, desert, etc.), or a particular company (e.g., Toyota). The template structures can be used to replace or cover, by virtual overlays or otherwise, objects in the driving environment recreation. The template structures can also define one or more objects without a real-world counterpart.

In one or more arrangements, the data store(s) 120 can include preference data 126. The preference data 126 can include theme preferences for one or more vehicle occupants. The preference data 126 can also include vehicle occupant preferences for various points of interest in a driving environment. Such points of interest can include restaurants (including particular types of restaurants), coffee shops, bars, stores, events, entertainment, museums, parks, natural features, gas stations, auto repair shops, parking, and/or recreation, just to name a few possibilities. The preference data 126 can be a list of potential points of interest for any user (and from which a vehicle occupant can select). Alternatively or additionally, the preference data 126 can be input by one or more users.

In one or more arrangements, the data store(s) 120 can include occupant data 128. The occupant data 128 can include information about a vehicle occupant, such as descriptive and/or physical features of height, weight, age, sex, biometric information, and/or any other information or attributes. The occupant data 128 can include any information that can be used to identify a vehicle occupant. The occupant data 128 can include historical information about a vehicle occupant. For instance, the historical information can include information about specific businesses or places that the vehicle occupant visits, the frequency of such visits, and other information about such visits (e.g., time of day, day of the week, time of the year, etc.)

The vehicle 100 can include one or more sensors 130. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the vehicle 100 includes a plurality of sensors, the sensors can work independently from each other. Alternatively, two or more of the sensors can work in combination with each other. In such case, the two or more sensors can form a sensor network.

The sensor(s) 130 can include any suitable type of sensor. Various examples of different types of sensors will be described herein. However, it will be understood that the embodiments are not limited to the particular sensors described.

The sensor(s) 130 can include one or more vehicle sensors 132. The vehicle sensor(s) 132 can be any suitable sensor, now known or later developed. The vehicle sensor(s) 132 can be configured to detect, determine, assess, monitor, measure, quantify and/or sense information about the vehicle 100 itself (e.g., position, location, orientation, speed, acceleration, heading, etc.) or one or more components or systems thereof. As an example, the vehicle sensor(s) 132 can include one or more speedometers, one or more fuel gauges, one or more fluid gauges, and/or one or more tire wear sensors. In some arrangements, the vehicle sensor(s) 132 can include one or more sensors for detecting and/or identifying audio played on an in-vehicle device.

The sensor(s) 130 can include one or more driving environment sensors 134. Such sensors can be used to detect, determine, assess, monitor, measure, quantify, acquire, and/or sense, directly or indirectly, something about the external or driving environment of the vehicle 100. For instance, one or more of the driving environment sensors 134 can be used to detect, determine, assess, monitor, measure, quantify, acquire, and/or sense, directly or indirectly, the presence of one or more objects in the driving environment of the vehicle 100, the position or location of each detected object relative to the vehicle 100, the distance between each detected object and the vehicle 100 in one or more directions (e.g., in a longitudinal direction, a lateral direction, and/or other direction(s)), the elevation of a detected object, the speed of a detected object, the acceleration of a detected object, the heading angle of a detected object, and/or the movement of each detected obstacle. The driving environment sensor(s) 134 can be any suitable sensor, now known or later developed. In one or more arrangements, the driving environment sensor(s) 134 can include one or more radar sensors, one or more lidar sensors, one or more sonar sensors, one or more cameras, one or more other type of sensors, and/or any combination thereof.

The sensor(s) 130 can include one or more occupant sensors 136. The occupant sensor(s) 136 can be configured to detect, determine, assess, monitor, measure, quantify and/or sense information about an occupant (e.g., driver and/or passenger) of the vehicle 100.

In one or more arrangements, the occupant sensor(s) 136 can be configured to detect or can acquire information or data that can be used to detect the presence, weight, voice, height, eye color, retina, hair color, and/or other information about a vehicle occupant. In some arrangements, the occupant sensor(s) 136 can include one or more cameras, one or more biometric sensors, one or more eye scanners, one or more retina scanners, one or more weight sensors, one or more proximity sensors, and/or one or more microphones. In some arrangements, the occupant sensor(s) 136 can be used to acquire and/or analyze speech or conversation of a vehicle occupant.

The vehicle 100 can include one or more input interfaces 140. An “input interface” includes any device, component, system, element or arrangement or groups thereof that enable information/data to be entered into a machine. The input interface(s) 140 can receive an input from a user (e.g., a person) or other entity. Any suitable input interface(s) 140 can be used, including, for example, a keypad, display, touch screen, multi-touch screen, button, joystick, mouse, trackball, microphone, gesture recognition (radar, lidar, camera, or ultrasound-based), and/or combinations thereof.

The vehicle 100 can include one or more output interfaces 145. An “output interface” includes any device, component, system, element or arrangement or groups thereof that enable information/data to be presented to a user (e.g., a person) or other entity. The output interface(s) 145 can present information/data to a user or other entity. The output interface(s) 145 can include a display, an earphone, a haptic device, a projector, and/or speaker. Some components of the vehicle 100 may serve as both a component of the input interface(s) 140 and a component of the output interface(s) 145.

The vehicle 100 can include one or more displays 150. The display(s) 150 can be any suitable type of display, now known or later developed. In some arrangements, the display(s) 150 can be part of another device located in the vehicle 100 and/or operatively connected to the vehicle 100. For example, the display(s) 150 can be part of an extended reality device. The display(s) 150 can be part of a device worn by a vehicle occupant, such as an extended reality headset. Extended reality (XR) refers to any combination of real-and-virtual environments, including an entirely virtual environment. Examples of XR include augmented reality (AR), mixed reality (MR), virtual reality (VR), and any type of reality in between these types of XR.

In some arrangements, the display(s) 150 can be a part of the input interface(s) 140 and/or the output interface(s) 145. In one or more arrangements, the display(s) 150 can be a part of the vehicle 100, such as a display integrated into an instrument panel or head unit of the vehicle 100. For instance, the display(s) 150 can be an infotainment display or head-unit located within the vehicle 100. In some arrangements, the display(s) 150 can be formed by a projector projecting the video onto a surface within the vehicle 100, such as by a heads-up display. For instance, video can be presented on a window (e.g., front windshield, side window, etc.) or an instrument panel of the vehicle 100.

The vehicle 100 can include one or more modules, at least some of which will be described herein. The modules can be implemented as computer readable program code that, when executed by a processor, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively or additionally, one or more data store 120 may contain such instructions.

For instance, the vehicle 100 can include one or more navigation modules 160. The navigation module(s) 160 can be configured to: determine a current geographic location of the vehicle 100, determine one or more travel routes between an origin and a destination, determine one or more revised travel routes based on a changed condition (e.g., route, location, traffic, etc.), determine a distance for a determined or selected travel route and/or determine an estimated time of arrival for a determined or selected travel route. The navigation module(s) 160 can use any navigation software, program, or algorithm, now known or later developed. In one or more arrangements, the navigation module(s) 160 can include, have access to and/or can execute one or more mapping applications or map data to determine a travel route between an origin and a destination.

The navigation module(s) 160 can include or operate in combination with a positioning system, which can include, for example, a global positioning system, a local positioning system or a geolocation system. The positioning system may include a transceiver configured to estimate a position of the vehicle 100 with respect to the Earth. For example, positioning system can include a GPS transceiver to determine the vehicle's latitude, longitude and/or altitude. The positioning system can use other systems (e.g., laser-based localization systems, inertial-aided GPS, and/or camera-based localization) to determine the location of the vehicle 100.

The navigation module(s) 160 can be configured to obtain traffic condition information or data from any suitable source of such information or data. For instance, the navigation module(s) 160 can be communicatively linked to one or more traffic data sources through one or more communication networks.

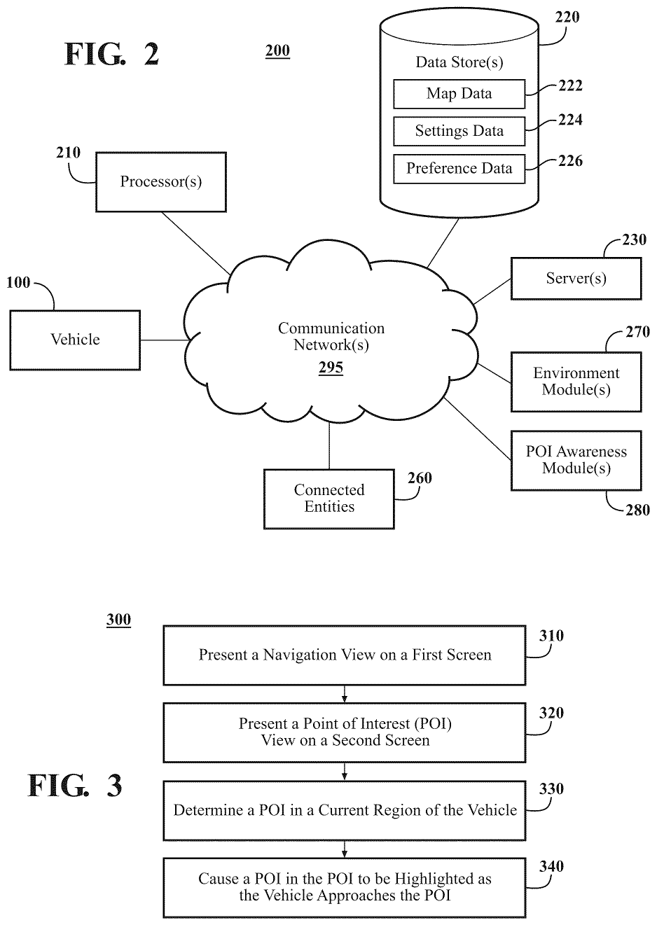

The vehicle 100 can include one or more environment modules 170. The environment module(s) 170 can create a themed version of the external environment of the vehicle 100. The environment module(s) 170 can cause the themed version of the external environment to be presented on the display(s) 150. The environment module(s) 170 can use information and data in the data store(s) 120 (e.g., the map data 122, the settings data 124, the preference data 126, and/or the occupant data 128), the driving environment sensor(s) 134 (e.g., camera(s) and/or other sensor(s)), and/or one or more external sources (e.g., the data store(s) 220 and/or the connected entities 260 in FIG. 2) to create the themed version of the external environment. The creation of the themed version of the external environment can be performed automatically, in response to a user input or command (e.g., on the input interface(s) 140), or even randomly.

The environment module(s) 170 can create a navigation view of the external environment of the vehicle 100. In some arrangements, the navigation view can show an overhead view of the movement of the vehicle 100 in the local environment. In some arrangements, the navigation view can show a ground-level or near ground level view of the movement of the vehicle 100 in the local environment. In some arrangements, the path of the vehicle 100 can be highlighted in the navigation view. In some arrangements, there can be a representation of the vehicle 100 in the navigation view.

The environment module(s) 170 can also create a point of interest (POI) view of the external environment. The POI view can show a broader view of a current region in which the vehicle is located. The POI view can show the location of the vehicle 100. In other arrangements, the POI view does not show the location of the vehicle 100. In some arrangements, the POI view can move with the vehicle 100 as it progresses along its path.

In some arrangements, the environment module(s) 170 can cause the navigation view to be presented on a first screen and the POI view to be presented on a second screen. The first screen and the second screen can be a part of the display(s) 150. In some arrangements, the first screen and the second screen can be presented on different parts of the same display 150. In some arrangements, the first screen can be presented on a first display, and the second screen can be presented on a second display. The first display and the second display can be separate displays.

The navigation view and the POI view can provide a rich immersive environment that is themed using extended reality (XR) elements. The environment module(s) 170 can be configured to augment the views in any suitable manner. For instance, virtual overlays can be presented over portions of the views or visual data acquired by the environment sensor(s) 134. The virtual overlays can be generated using one or more of the template structures in the settings data 124. The virtual overlays can be presented over corresponding real-world objects and/or environment in the views. As another example the environment module(s) 170 can be configured to augment the view by applying extended reality modifications to real-world objects or environment.

In some arrangements, the navigation view and/or the POI view can include one or more objects without a real-world counterpart. For instance, the POI view can present extended reality (XR) objects within in the POI view that do not have a real-world counterpart. As an example, the POI view can show a building (or other object) in a location where there is no building in the real-world environment (e.g., in a vacant lot or field). Such object can be included to make the environment more immersive in a selected theme and/or to enhance interest of and/or engagement by a vehicle occupant.

The vehicle 100 can include one or more point of interest (POI) awareness modules 180. The POI awareness module(s) 180 can be configured to identify POIs in the driving environment of the vehicle 100. The POI awareness module(s) 180 can be configured to do so in any suitable manner. For instance, the POI awareness module(s) 180 can be configured to use vehicle route information (e.g., from the navigation module(s) 160), the map data 122, the preference data 126, the occupant data 128, sensor data from the sensor(s) 130, or any combination thereof. For instance, the POI awareness module(s) 180 can verify whether any of a user's preferred POIs (e.g., restaurants or coffee shops) are located along a current route of the vehicle 100.

In some arrangements, the POI awareness module(s) 180 can be configured to determine a POI based on a vehicle condition or other real-time conditions (including non-vehicle related conditions). For example, the POI awareness module(s) 180 can detect that the fuel level or charging level of the vehicle 100 is low (e.g., below a threshold amount). The POI awareness module(s) 180 can analyze map data 122 and/or route data to determine whether there are any gas stations or charging stations located along the current route of the vehicle 100.

The POI awareness module(s) 180 can be configured to highlight the POIs to an occupant of a vehicle. The highlighting can be performed in the POI view. Any suitable form of highlighting can be used. For instance, the POI awareness module(s) 180 can be configured to cause a POI in the POI view to be highlighted by making the POI view flyby or flyover the identified POI. As another example, the POI awareness module(s) 180 can be configured to cause a POI in the POI view to be highlighted by zooming in on the POI.

Zooming in on the POI can include presenting a real-time visual data or audio data at the POI. Such real-time visual data or audio data can give a user a sense of how crowded a POI may be. For instance, if the POI is a restaurant, the POI awareness module(s) 180 can obtain real-time data at the POI (e.g., from cameras or microphones at the POI and/or from individuals at the POI (e.g., people waiting inside or outside restaurant). In the POI view, the POI awareness module(s) 180 can visually zoom in on the POI, and it can also present real-time visual data and/or audio data at the POI. Such information can give a user a sense of what it happening at the POI and can inform a user's decision on whether to go to the POI.

As still another example, the POI awareness module(s) 180 can be configured to cause a POI in the POI view to be highlighted by rotating the POI view by rotating about the POI. As yet another example, the POI awareness module(s) 180 can be configured to cause a POI in the POI view to be highlighted by causing one or more objects to glow, to be highlighted, to be enlarged, and/or to otherwise be offset.

In some arrangements, the POI awareness module(s) 180 can be configured to present an object that does not have a real-world counterpart. For instance, the POI awareness module(s) 180 can cause an object to be presented in the POI view to highlight the POI. As an example, the POI awareness module(s) 180 can cause a character to be presented holding or using an object that relates to the POI. For example, a character can be holding an electric vehicle charging cable. Such a character can be positioned in any suitable location relative to the POI, such as at, near, on, above, beside, or under the POI. Or the character can be moving around the POI.

The suggestion and display of POIs along a route of the vehicle within the display arrangements described herein can enhance driver and/or passenger awareness. The display can present two separate views. A first view (navigation view) can show an immediate navigation environment in relation to immediate driving control and navigation considerations. A second view (POI view) can show POI highlights according to a current location along a route. The POI view can be related to the navigation/control view in that the POI view provides a broader view of the region and highlights POIs as the vehicle passes.

The vehicle 100 can accumulate information about the vehicle occupant(s) in relation to attributes of the occupants (e.g., age, sex, etc.) and/or preferences of the occupants. Using such information, the POI awareness module(s) 180 can identify and suggest different POIs as the vehicle 100 progresses along a route. When suggesting the POIs, the POI awareness module(s) 180 can provide an indicator of the POI, but it can also render the POI view to perform another visually rich animation in the themed environment to draw the attention of the occupant(s) to the POI.

In some arrangements, the POI-view may display visual renderings of the themed environment for POIs at which a vehicle occupant has performed a pointing query. That is, the vehicle occupant can point at an aspect of the surrounding environment and/or speak a query about the POI at which they are pointing. The POI awareness module(s) 180 can then focus the POI view on the pointed POI with a visual highlighting animation (e.g., fly-by, zoom, or other animation). The POI awareness module(s) 180 can also cause information about the POI to be presented.

The POI awareness module(s) 180 can also cause information about waypoints along a programmed route, POIs related to a current condition of the vehicle (e.g., gas stations when the vehicle needs gas), etc. to be displayed. When highlighting the POIs, the POI awareness module(s) 180 can use special visual animations to make the experience more immersive. Additionally, the environment module(s) 170 and/or the POI awareness module(s) 180 can theme the views in a 3D format according to a desired style. In some arrangements, the environment module(s) 170 and/or the POI awareness module(s) 180 can use generative artificial intelligence to create the themed version of the external environment and/or the highlighting of a POI.

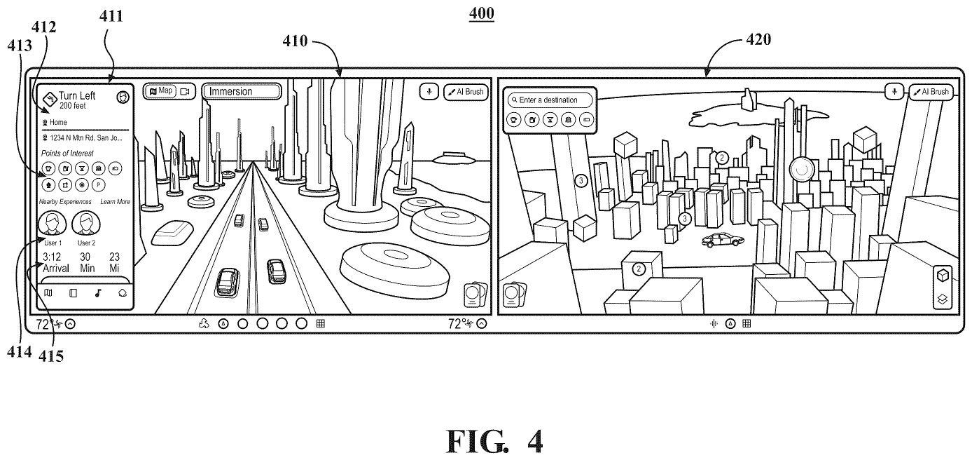

One example of the navigation view and the POI view will now be presented in connection with FIG. 4. It will be appreciated that these views are non-limiting examples. FIG. 4 shows an example of a display 400 with a split screen is shown. The split screen can include a first screen 410 and a second screen 420. The first screen 410 and the second screen 420 can be presented on different potions of the same display, or they can be presented on separate displays.

The first screen 410 can present a navigation view. The navigation view can show the vehicle level view and changes with the movement of the vehicle 100. The navigation view can be an overhead view or a ground level view of the immediate area of the vehicle 100. The second screen 420 can present a POI view. In this example, the POI view is an overhead view of the broader region in which the vehicle 100 is located. In some instances, the POI view can include a POI. The POI can be highlighted in any suitable way, such as by making the POI larger than the surrounding environment. Examples of such highlighting will be described herein.

In some arrangements, the navigation view can present a control section 411. The control section 411 can present various information and/or options to a user. For instance, the control section 411 can present navigation directions 412. Alternatively or additionally, the control section 411 can allow a user to select POIs from a menu of POIs 413. Alternatively or additionally, the control section 411 can allow a user to select from list of predefined or stored user profiles 414. Alternatively or additionally, the control section 411 can present other travel information 415, such as predicted arrival time, remaining time, and/or remaining distance. It will be appreciated that the control section 411 in FIG. 4 is merely one example of a control section, as there can be additional content or less content than what is shown. Further, in some arrangements, the control section 411 can be presented on a different screen (e.g., the second screen 420 or an entirely different screen).

In FIG. 4, the first screen 410 and the second screen 420 are arranged horizontally side-by-side with the first screen 410 on the left and the second screen 420 on the right. However, it will be appreciated that this arrangement is a non-limiting example. Indeed, the first screen 410 and the second screen 420 can be reversed. Further, the first screen 410 and the second screen 420 can be arranged in a vertically side-by-side manner with one of the screens on top and the other screen on the bottom. In some arrangements, the first screen 410 and the second screen 420 can be adjacent to each other. In some cases, the first screen 410 and the second screen 420 can be spaced from each other. In some instances, there can be more than two screens, presenting additional views or the control section 411. Additional non-limiting examples of split screen arrangements will be described later in this description.

In some arrangements, the vehicle 100 can include one or more autonomous driving modules 190. The autonomous driving module(s) 190 can receive data from the sensor(s) 130 and/or any other type of system capable of capturing information relating to the vehicle 100 and/or the external environment of the vehicle 100. The autonomous driving module(s) 190 can determine position and velocity of the vehicle 100. The autonomous driving module(s) 190 can determine the location of objects, obstacles, or other environmental features including traffic signs, trees, shrubs, neighboring vehicles, pedestrians, etc.

The autonomous driving module(s) 190 can determine travel path(s), current autonomous driving maneuvers for the vehicle 100, future autonomous driving maneuvers and/or modifications to current autonomous driving maneuvers based on data acquired by the sensor(s) 130, driving scene models, and/or data from any other suitable source. “Driving maneuver” means one or more actions that affect the movement of a vehicle. Examples of driving maneuvers can include accelerating, decelerating, braking, turning, moving in a lateral direction of the vehicle 100, changing travel lanes, merging into a travel lane, and/or reversing, just to name a few possibilities. The autonomous driving module(s) 190 can cause, directly or indirectly, such autonomous driving maneuvers to be implemented. As used herein, “cause” or “causing” means to make, force, compel, direct, command, instruct, and/or enable an event or action to occur or at least be in a state where such event or action may occur, either in a direct or indirect manner. The autonomous driving module(s) 190 can execute various vehicle functions and/or can transmit data to, receive data from, interact with, and/or control the vehicle 100 or one or more systems thereof. In some arrangements, the autonomous driving module(s) 190 and/or the processor(s) 110 can send signals to one or more actuators to modify, adjust and/or alter one or more vehicle systems or components thereof. The actuators can include motors, pneumatic actuators, hydraulic pistons, relays, solenoids, and/or piezoelectric actuators, just to name a few possibilities.

The processor(s) 110 and/or the autonomous driving module(s) 190 can be operatively connected to communicate with various vehicle systems and/or individual components thereof. For example, the processor(s) 110 and/or the autonomous driving module(s) 190 can be in communication to send and/or receive information from various vehicle systems to control the movement, speed, maneuvering, heading, direction, etc. of the vehicle 100. The processor(s) 110 and/or the autonomous driving module(s) 190 may control some or all of these vehicle systems and, thus, may be partially or fully autonomous. For instance, when operating in an autonomous mode, the processor(s) 110 and/or the autonomous driving module(s) 190 can control the direction and/or speed of the vehicle 100. The processor(s) 110 and/or the autonomous driving module(s) 190 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). In some arrangements, the vehicle 100 may not include the autonomous driving module(s) 190.

The various elements of the vehicle 100 can be communicatively linked through one or more communication networks 195. As used herein, the term “communicatively linked” can include direct or indirect connections through a communication channel or pathway or another component or system. A “communication network” means one or more components designed to transmit and/or receive information from one source to another. The communication network(s) 195 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets.

The communication network(s) 195 further can be implemented as or include one or more wireless networks, whether short or long range. For example, in terms of short-range wireless networks, the communication network(s) 195 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long-range wireless networks, the communication network(s) 195 can include a mobile, cellular, and or satellite-based wireless network and support voice, video, text, and/or any combination thereof. Examples of long-range wireless networks can include GSM, TDMA, CDMA, WCDMA networks or the like. In one or more arrangements, the communication network(s) 195 can include Vehicle-to-Vehicle (V2V), Vehicle-to-Infrastructure (V2I), or Vehicle-to-Everything (V2X) technology, which can allow for communications between one or more elements of the vehicle 100 and/or one or more elements located remote from the vehicle 100. The communication network(s) 195 can include wired communication links and/or wireless communication links. The communication network(s) 195 can include any combination of the above networks and/or other types of networks. The communication network(s) 195 can include one or more routers, switches, access points, wireless access points, and/or the like.

One or more elements of the vehicle 100 can include and/or can execute suitable communication software, which enables two or more of the elements to communicate with each other through the communication network(s) 195 and perform the functions disclosed herein.

The vehicle 100 can be part of a larger system. FIG. 2 is an example of a system 200. The system 200 can include various elements. Some of the possible elements of the system 200 are shown in FIG. 2 and will now be described. The system 200 can have any combination of the various elements shown in FIG. 2. Further, the system 200 can have additional elements to those shown in FIG. 2. Of course, it will be understood that it is not necessary for the system 200 to have all of the elements shown in FIG. 2 or described herein. Further, the elements shown may be physically separated by large distances. Indeed, one or more of the elements can be located remotely from the other elements.

The system 200 can include the vehicle 100, one or more processors 210, one or more data stores 220, one or more server(s) 230, one or more environment modules 270, one or more POI awareness modules 280, and/or one or more connected entities 260. The various elements of the system 200 can be communicatively linked through one or more communication networks 295. The above discussion of the communication network(s) 195 in connection with FIG. 1 applies equally to the communication network(s) 295 in FIG. 2. Further, while FIG. 2 only shows the environment module(s) 270 and the POI awareness module(s) 280, it will appreciated that the system 200 can include any of the module(s) described in connection with FIG. 1 above as well as other modules. Also, in some instances, the system 200 may not include the environment module(s) 270 and/or the POI awareness module(s) 280.

With respect to the processor(s) 210, the data store(s) 220 (including map data 222, settings data 224, and preference data 226), and the environment module(s) 270, and the POI awareness module(s) 280, the above discussion of the processor(s) 110, the data store(s) 120 (including the map data 122, the settings data 124, and the preference data 126), the environment modules 170, and/or the POI awareness modules 180 in connection with FIG. 1 applies equally here. Indeed, the processor(s), the data store(s), and/or any of the module(s) can be located entirely on the vehicle 100, entirely remote from the vehicle 100, or partially on the vehicle 100 and partially remote from the vehicle 100. It will be appreciated that the above discussion of the vehicle 100 in connection with FIG. 1 applies equally to the vehicle 100 shown in the system 200 of FIG. 2. Further, the system 200 can include any of the other modules described in connection with FIG. 1.

The system 200 can include one or more servers 230. The server(s) 230 can be located remote from the vehicle 100 and/or the connected entities 260. The server(s) 230 can be any type of server, now known or later developed. In some arrangements, the server(s) 230 can be cloud-based server(s) or edge server(s). The server(s) 230 can communicate with the vehicle 100 and/or with the connected entities 260 over the communication network 295.

In some arrangements, the system 200 can include one or more connected entities 260. A connected entity can include any device that is communicatively coupled to the server(s) 230 and/or the vehicle 100. Non-limiting examples of the connected entities 260 include one or more connected vehicles, one or more connected infrastructure devices, and/or one or more connected personal devices. The vehicle 100 can be configured to communicate directly with the connected entities 260 and/or via the server(s) 230. The connected entities 260 can provide data or information to any of the elements in the system 200 or the vehicle 100. Such data and information can be useful in creating navigation map(s) and/or point of interest awareness displays according to arrangements described herein.

With respect to the connected vehicle(s), the above discussion of the vehicle 100 in FIG. 1 can apply equally to the connected vehicle(s). The connected vehicle(s) can be any vehicle. The connected vehicle(s) can be configured to acquire driving environment data. In some arrangements, the connected vehicle(s) can be configured to send and/or receive information to the server(s) 230.

Regarding the connected infrastructure device(s), an “infrastructure device” can be any device positioned along or near a road or other travel path. The connected infrastructure device(s) can be configured to acquire driving environment data. The connected infrastructure device(s) can be configured to acquire driving environment data include one or more sensors for sensing the surrounding environment and/or for sensing vehicles, structures, pedestrians, and/or other objects in the environment. The discussion of the driving environment sensors 134 in connection with FIG. 1 is applicable to the environment sensors of the connected infrastructure device(s).

The connected infrastructure device(s) can be, for example, a CCTV camera, a roadside camera, a road side unit (RSU), a street light, traffic light, a smart traffic light, a traffic sign, a road sign, a billboard, a bridge, a building, a pole, or a tower, just to name a few possibilities. In some instances, the connected infrastructure device(s) can be a road itself when the operative components are embedded therein. In some arrangements, the connected infrastructure device(s) can be configured to send and/or receive information to the server(s) 230.

The connected personal device(s) can include any portable device worn or carried by a person, now known or later developed. The connected personal device(s) can include one or more environment sensors for sensing at least a portion of the surrounding environment of the connected personal device(s). The discussion of the driving environment sensors 134 in connection with FIG. 1 is applicable to the environment sensors of the connected personal device(s).

Examples of the connected personal device(s) can include a telephone (e.g., a cellular telephone, a smart phone, etc.) a computer (e.g., a laptop, a tablet, a phablet, etc.), and/or any other a portable computing device. In one or more arrangements, the connected personal device(s) can include a smart watch, smart eye glasses, smart jewelry (e.g., neckless, earrings, bracelets, etc.), gaze tracking enabled goggles, smart contact lenses, and/or smart clothing (e.g., a shirt, hat, or other article of clothing enabled for wireless communication).

The connected entities 260 can be configured to acquire driving environment data. The connected entities 260 can be configured to communicate directly with the vehicle 100 and/or the connected entities 260 or indirectly via the server(s) 230.

In some instances, driving environment data acquired by the connected entities 260 can be sent to the server(s) 230. In some arrangements, the server(s) 230 can be configured to analyze the acquired sensor data. In some arrangements, the server(s) 230 can be configured to send driving environment data acquired by the connected entities 260 to the vehicle 100.

Now that the various potential systems, devices, elements and/or components of the vehicle 100 and the system 200 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

Turning to FIG. 3, an example of a method 300 is shown. At block 310, a navigation view can be presented on a first screen. The first screen can be defined by the display(s) 150. The navigation view can be presented by the navigation module(s) 160, the environment module(s) 170, and/or the processor(s) 110. The method 300 can continue to block 320.

At block 320, a point of interest (POI) view can be presented on a second screen. The POI view being a broader view of a current region in which the vehicle 100 is located. The POI view including one or more objects without a real-world counterpart.

The second screen can be defined by the display(s) 150. In some instances, the first screen and the second screen can be presented on the same display (e.g., different regions of the same display), or they can be presented on different displays. The POI view can be presented by the navigation module(s) 160, the environment module(s) 170, the POI awareness module(s) 180, and/or the processor(s) 110. The method 300 can continue to block 330.

At block 330, a POI in the current region can be determined. Such a determination can be made by the POI awareness module(s) 180 and/or the processor(s) 110. The determination can be made using data from the sensor(s) 130 (e.g., an occupant sensor(s) 136) and/or the preference data 126. The method 300 can continue to block 340.

At block 340, a POI in the POI view can be caused to be highlighted as the vehicle approaches the POI. Such causing can be performed by the POI awareness module(s) 180 and/or the processor(s) 110.

The method 300 can end. Alternatively, the method 300 can return to block 310 or to some other block. The method 300 can be repeated at any suitable point, such as at a suitable time or upon the occurrence of any suitable event or condition.

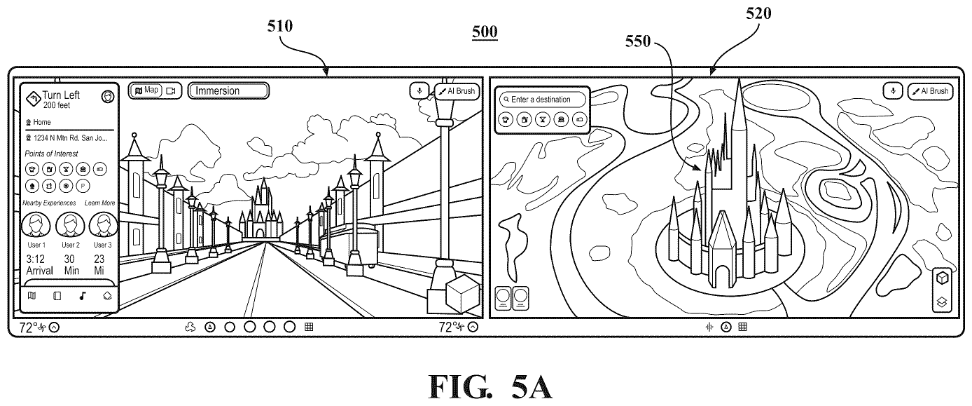

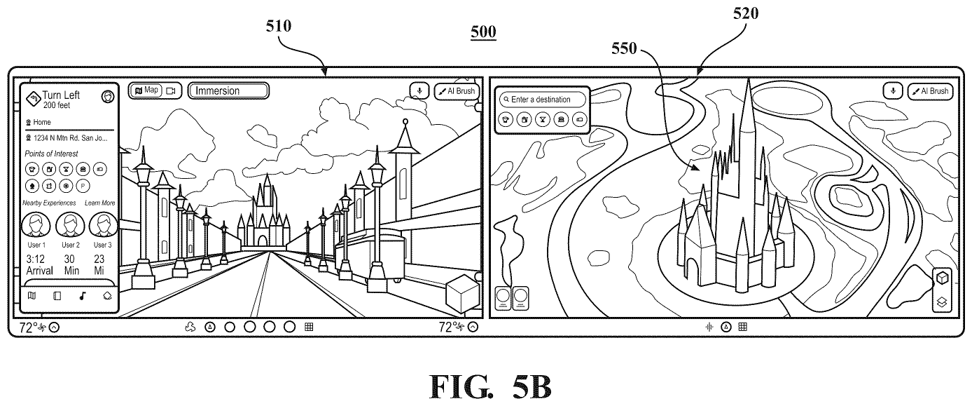

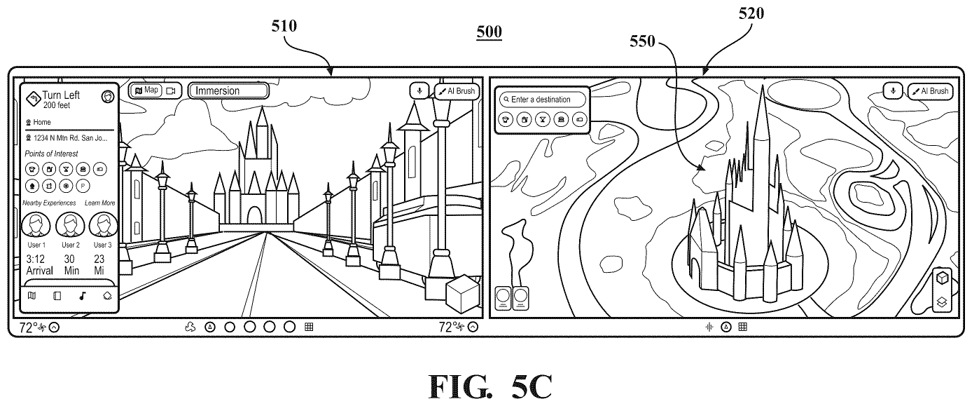

Various examples of the navigation view and the POI view will now be presented in connection with FIGS. 5-8. It will be appreciated that these views are non-limiting examples.

Referring to FIGS. 5A-5C, an example of a display 500 with a split screen is shown. FIG. 5A-5C show represent examples of the display 500 over a sequential series of time with FIG. 5A being a first moment in time, FIG. 5B being a second moment in time (subsequent to the first moment in time), and FIG. 5C being a third moment in time (subsequent to the second moment in time). The split screen includes a first screen 510 and a second screen 520. The first screen 510 can present a navigation view. The navigation view shows the vehicle level view and changes with the movement of the vehicle 100. The second screen 520 can present a POI view. In this example, the POI view is an overhead view of the broader region in which the vehicle 100 is located. The POI view includes a POI 550. The POI 550 (or the entire POI view) can rotate as the vehicle 100 moves along its path. The navigation view and the POI view can be represented in a Disney-like theme.

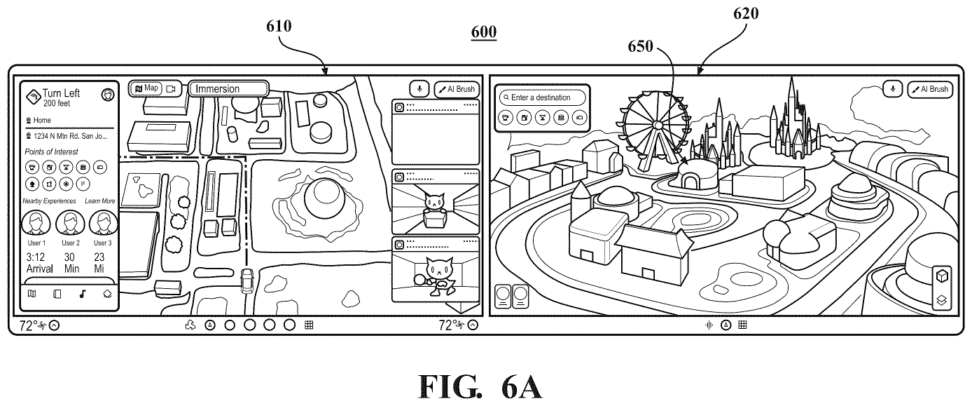

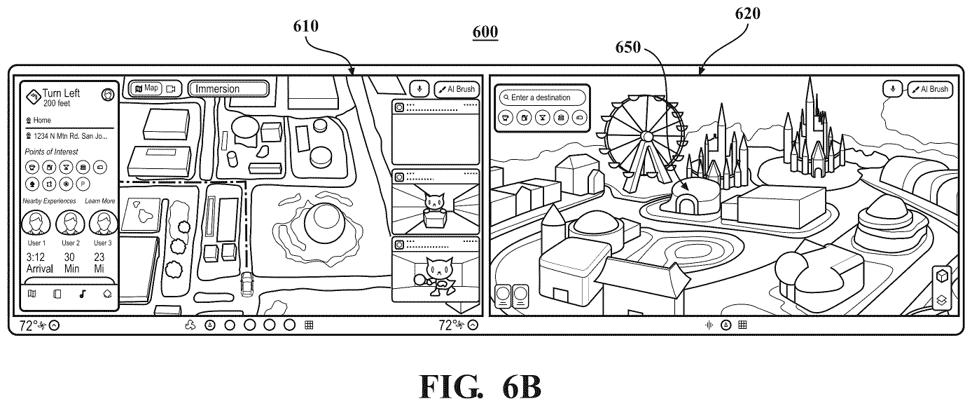

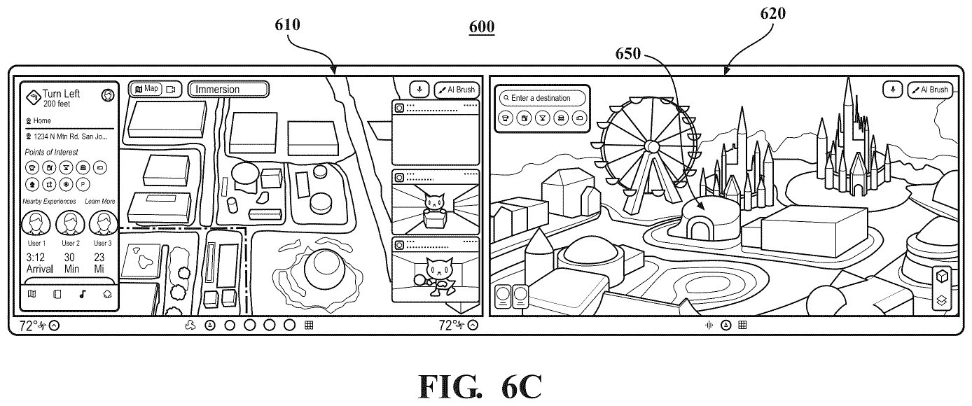

In FIGS. 6A-6C, an example of a display 600 with a split screen is shown. FIG. 6A-6C show represent examples of the display 600 over a sequential series of time with FIG. 6A being a first moment in time, FIG. 6B being a second moment in time (subsequent to the first moment in time), and FIG. 6C being a third moment in time (subsequent to the second moment in time). The split screen includes a first screen 610 and a second screen 620. The first screen 610 can present a navigation view. The first screen 610 can show an overhead view of the movement of the vehicle 100 in the driving environment. The path of the vehicle 100 can be highlighted.

The navigation view shows the vehicle level view and changes with the movement of the vehicle 100. The second screen 620 can present a POI view. In this example, the POI view can a flyover view of the broader region in which the vehicle 100 is located. The POI view includes a POI 650. The POI view can present a flyover of the POI 650 as the vehicle 100 moves along its path. The navigation view and the POI view can be represented in a Hello Kitty-like theme.

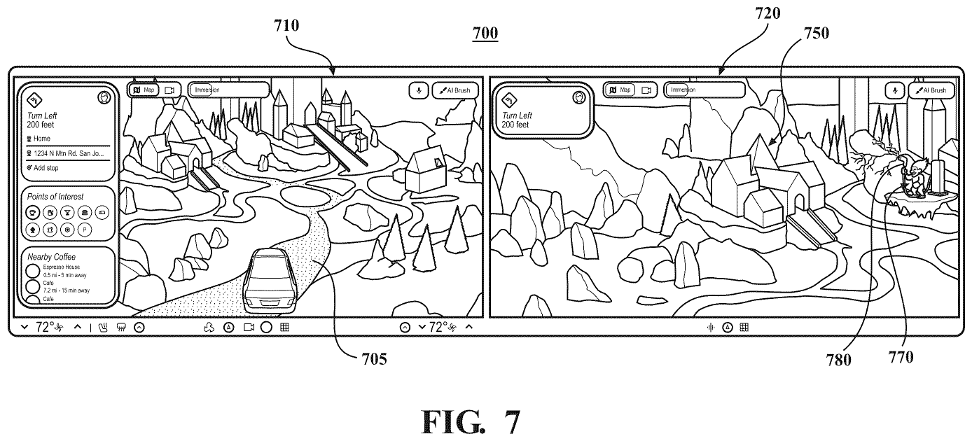

In FIG. 7, an example of a display 700 with a split screen is shown. The split screen includes a first screen 710 and a second screen 720. The first screen 710 can present a navigation view. The first screen 710 can show an overhead view of the movement of the vehicle 100 in the driving environment. The path 705 of the vehicle 100 can be highlighted.

The second screen 720 can present a POI view. In this example, the POI view can present a closer view of a portion of the navigation view, showing a dwelling 750.

Here, the POI awareness module(s) 180 can determine that a charge level of the vehicle is below a threshold. In such case, the POI awareness module(s) 180 can analyze route data and map data 122 to determine if there is a charging station along the route of the vehicle. In this case, the POI awareness module(s) 180 identifies a charging station along the route. Accordingly, the POI awareness module(s) 180 can cause the POI to be highlighted by presenting a character 770 holding a charging plug 780. The character and/or the charging plug can be animated to draw the attention of a vehicle occupant and/or to particularly highlight one POI among a plurality of POIs. For instance, animated sparks can be shown emanating from the charging plug. The character can be part of a larger theme presented on this display 700.

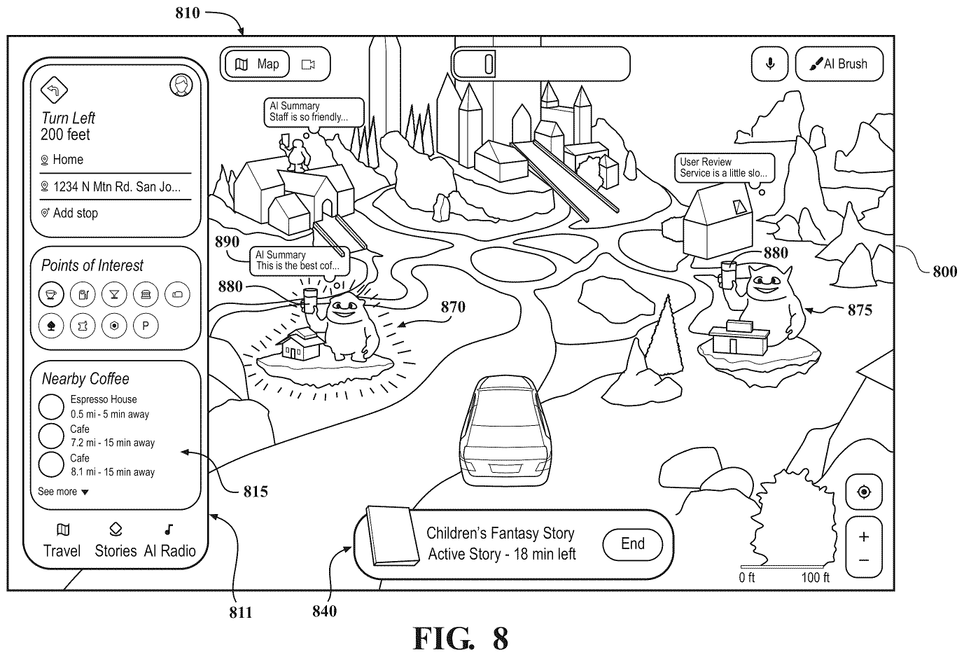

In FIG. 8, an example of a display 800 is shown. Unlike the other displays described herein, the display 800 is a single screen 810, combining elements of the navigation view and the POI view. Here, the screen 810 can present a navigation view, showing an overhead view of the movement of the vehicle 100 in the driving environment. The path of the vehicle 100 can be highlighted. In this case, the user can select coffee as a POI from the choices in the point of interest section of the control screen 811.

The POI awareness module(s) 180 can analyze route data and map data 122 to determine if there are any coffee shops along the route of the vehicle. In this case, the POI awareness module(s) 180 identifies a plurality of coffee shops along the route. Accordingly, the POI awareness module(s) 180 can cause the POIs to be highlighted by presenting a first character 870 and a second character 875, each holding a coffee cup 880. And, among the plurality of characters, there can be further highlighting to indicate that a coffee shop that is a preference of a vehicle occupant or one that has better reviews or ratings than the other coffee shops. Such further highlighting can include causing the character to glow (e.g., the first character 870 is glowing), have thought or speech bubbles 890, and/or any other form of highlighting. Also, the control screen 811 can display a list 815 of nearby coffee shops.

The XR content presented on the display 800 can be part of a theme. In this instance, the theme can be selected based on real-time information. For instance, a vehicle occupant may be playing an audiobook in the vehicle 100. The environment module(s) 170 can identify the audiobook by communicating with another system or component of the vehicle 100 or by analyzing audial output from the output interface(s) 145. Once the book is identified, the environment module(s) 170 and/or the POI awareness module(s) 180 can create virtual overlays in a theme consistent with the audiobook. For instance, if the audiobook is from a particular genre, then the environment module(s) 170 and/or the POI awareness module(s) 180 can create virtual overlays with environments, characters, and/or objects within that specific audiobook or generally from that genre. The environment module(s) 170 and/or the POI awareness module(s) 180 can use generative AI to create virtual overlays of such environments, characters, and/or objects. In the example shown in FIG. 8, the audiobook 840 is in the children's fantasy genre. Accordingly, the environment can be rendered virtually with environments, characters, and/or objects from that particular audiobook or generally from that genre.

It will be appreciated that arrangements described herein can provide numerous benefits, including one or more of the benefits mentioned herein. For example, arrangements described herein can provide immersive map elements within a navigation map of a vehicle using passenger and route information to improve awareness of POIs. Arrangements described herein can provide a rich immersive environment that includes a themed overlay and multiple display screens to facilitate highlight POIs to occupants of a vehicle. Arrangements described herein can base the suggestions of POIs on occupant preferences. Arrangements described herein can provide providing a user with a highly customizable map driving experience.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
presenting a navigation view on a first screen;
presenting a point of interest (POI) view on a second screen, the POI view being a broader view of a current region in which a vehicle is located, the POI view including one or more objects without a real-world counterpart;
determining a POI in the current region; and
causing a POI in the POI view to be highlighted as the vehicle approaches the POI.

2. The method of claim 1, wherein causing a POI in the POI view to be highlighted includes a flyby of the POI.

3. The method of claim 1, wherein causing a POI in the POI view to be highlighted including zooming in on the POI.

4. The method of claim 3, wherein zooming in on the POI includes presenting a real-time visual data or audio data of the POI.

5. The method of claim 1, wherein causing a POI in the POI view to be highlighted including rotating about the POI.

6. The method of claim 1, wherein determining the POI is based on an occupant attribute or an occupant preference.

7. The method of claim 1, wherein determining the POI is based on a vehicle condition.

8. The method of claim 1, wherein the navigation view and the POI view are presented according to a theme.

9. The method of claim 8, wherein the theme is determined based on a user input.

10. The method of claim 8, wherein the theme is determined based on one or more real-time conditions.

11. A system comprising:
a processor configured to:
present a navigation view on a first screen;
present a point of interest (POI) view on a second screen, the POI view being a broader view of a current region in which a vehicle is located, the POI view including one or more objects without a real-world counterpart;
determine a POI in the current region; and
cause a POI in the POI view to be highlighted as the vehicle approaches the POI.

12. The system of claim 11, wherein causing a POI in the POI view to be highlighted includes a flyby of the POI, zooming in on the POI, or rotating about the POI.

13. The system of claim 12, wherein zooming in on the POI includes presenting a real-time visual data or audio data of the POI.

14. The system of claim 11, wherein determining the POI is based on an occupant attribute or an occupant preference.

15. The system of claim 11, wherein determining the POI is based on an or a vehicle condition.

16. The system of claim 11, wherein the navigation view and the POI view are presented according to a theme.

17. The system of claim 16, wherein the theme is determined based on a user input or one or more real-time conditions.

18. The system of claim 11, wherein the processor is located onboard the vehicle.

19. The system of claim 11, further including a display operatively connected to the processor, and wherein the first screen and the second screen are presented on different parts of the display.

20. The system of claim 11, further including a first display and a second display operatively connected to the processor, wherein the first screen is presented on the first display, and wherein the second screen is presented on the second display.
